(19) United States
(12) Patent Application Publication
(10) Pub. No.: US 2007/0060462 A1
(43) Pub. Date: Mar. 15, 2007

(54) Centrifuge

(76) Inventors: Takahiro Shimizu, Toyota-shi (JP); Yuki Shimizu, Hitachinaka-shi (JP); Hiroshi Hayasaka, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/520,639

(22) Filed: Sep. 14, 2006

(30) Foreign Application Priority Data
Sep. 14, 2005 (JP) P2005-266716

(51) Int. Cl. B04B 7/02; B04B 9/02

(52) U.S. Cl. 494/60; 494/84

(57) ABSTRACT

A centrifuge includes a frame, a motor, a output shaft, a rotational shaft, and a belt. The frame has a bottom portion. The motor is disposed in the frame to generate a driving force. The output shaft extends from the motor and has an end positioned in proximity to the bottom portion. The rotational shaft is disposed in the frame and has one end positioned in proximity to the bottom portion. The belt is supported on the end of the output shaft and the one end of the rotational shaft. The bottom portion is formed with an opening that opposes at least part of the belt.

### BACKGROUND OF THE INVENTION

The present invention relates to a centrifuge, and particularly to a tabletop centrifuge that is installed on a testing bench or the like.

Centrifuges with various structures have been proposed over the years. One such conventional centrifuge disclosed in U.S. Pat. No. 4,022,375 includes a motor base that is supported on the base of a frame via dampers. A motor and a shaft unit are juxtaposed on the motor base, while a driving force transmitting mechanism is disposed beneath the motor base. A belt in the driving force transmitting mechanism transmits the driving force of the motor to the shaft unit.

### SUMMARY OF THE INVENTION

However, since the motor, motor base, and shaft unit are all disposed above the belt in the centrifuge described above, the parts above the belt must be exposed when inspecting tension in the belt or replacing the belt. This requires a complex operation that can be time-consuming.

In view of the foregoing, it is an object of the present invention to provide a centrifuge capable of facilitating operations to check belt tension and to replace the belt, and capable of reducing the time required for such operations.

This and other object of the present invention will be attained by a centrifuge including a frame, a motor, a output shaft, a rotational shaft, and a belt. The frame has a bottom portion. The motor is disposed in the frame to generate a driving force. The output shaft extends from the motor and has an end positioned in proximity to the bottom portion. The rotational shaft is disposed in the frame and has one end positioned in proximity to the bottom portion. The belt is supported on the end of the output shaft and the one end of the rotational shaft. The bottom portion is formed with an opening that opposes at least part of the belt.

### BRIEF DESCRIPTION OF THE DRAWINGS

In the drawings:

FIG. 1 is a schematic diagram showing the general structure of a centrifuge according to a preferred embodiment of the present invention;

FIG. 2 is an exploded perspective view of the centrifuge according to the preferred embodiment; and

FIG. 3 is an exploded perspective view of a centrifuge according to a variation of the preferred embodiment.

### DESCRIPTION OF THE PREFERRED EMBODIMENTS

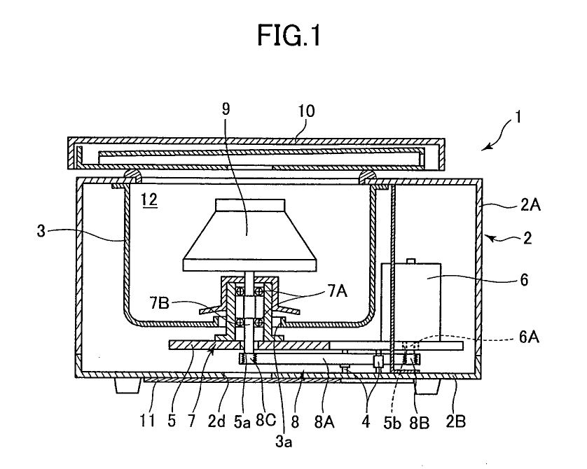

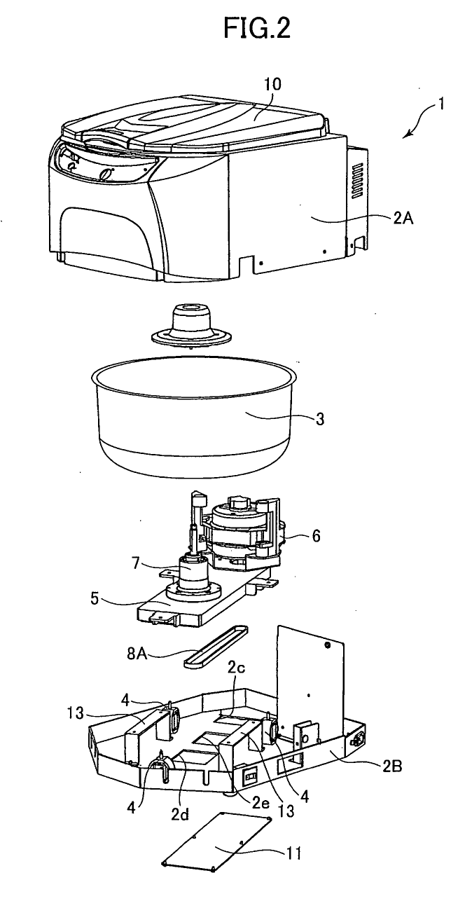

A centrifuge 1 according to a preferred embodiment of the present invention will be described with reference to FIGS. 1 and 2. The centrifuge 1 primarily includes a frame 2, a bowl 3, a plurality (three in the preferred embodiment) of dampers 4, a motor base 5, a motor 6, a shaft unit 7, a driving force transmitting mechanism 8, and a rotor 9. The frame 2 constitutes the outer frame of the centrifuge 1 and has a box shape with an open top. The frame 2 includes an upper frame 2A, and a base 2B. A cover 10 is provided on the top of the upper frame 2A and is capable of opening and closing over the opening in the top. As shown in FIG. 2, first through third openings 2c-2e are formed in the base 2B. A cover 11 is mounted on the lower side of the base 2B by screws or the like so as to be capable of being detached therefrom. The cover 11 is positioned to block the first through third openings 2c-2e for interrupting the flow of air between the inside of the frame 2 and the external air.

The bowl 3 is formed in a cylindrical shape having a bottom. A shaft unit insertion hole 3a is formed in the bottom portion of the bowl 3. The bowl 3 is disposed inside the frame 2 and is fixed to and supported on the frame 2 via bowl mounting parts 13. The bowl 3 defines a rotor chamber 12. The three dampers 4 are arranged in a triangular shape on the base 2B. The motor base 5 is substantially box-shaped with an open bottom and is supported on the dampers 4 mounted on the base 2B. For explanatory purposes, the motor base 5 is shown in a simplified plate shape in FIG. 1. A portion of the motor base 5 is positioned opposite the bowl 3. A shaft through-hole 5a is formed in the portion of the motor base 5 opposing the bowl 3. An output shaft through-hole 5b is formed in a portion of the motor base 5 that does not oppose the bowl 3.

The motor 6 is disposed on a side of the bowl 3 on the portion of the motor base 5 that does not oppose the bowl 3. The motor 6 has an output shaft 6A that penetrates the output shaft through-hole 5b and extends toward the base 2B. The output shaft 6A functions to output a driving force of the motor 6. The shaft unit 7 is disposed in the portion of the motor base 5 that opposes the bowl 3. The shaft unit 7 penetrates the shaft unit insertion hole 3a so that the top portion of the shaft unit 7 is positioned inside the rotor chamber 12. The shaft unit 7 includes two bearings 7A, and a vertically extended drive shaft 7B rotatably supported in the bearings 7A. The drive shaft 7B penetrates the shaft through-hole 5a, with one end positioned inside the rotor chamber 12 and the other end positioned below the motor base 5.

The driving force transmitting mechanism 8 is disposed below the motor base 5 and includes the belt 8A, a first pulley 8B, and a second pulley 8C. The first pulley 8B is coaxially fixed to the lower end of the output shaft 6A, and the second pulley 8C is coaxially fixed to the lower end of the drive shaft 7B. The belt 8A is mounted over the first and second pulleys 8B and 8C. The driving force transmitting mechanism 8 having this configuration transmits a driving force from the motor 6 to the drive shaft 7B. Further, the first and second pulleys 8B and 8C are positioned opposite the first and second openings 2c and 2d formed in the base 2B. A portion of the belt 8A corresponding to an approximate center region between the first and second pulleys 8B and 8C opposes the third opening 2e. The rotor 9 is connected to the upper end of the drive shaft 7B and is capable of rotating together with the drive shaft 7B for separating a target material from a sample.

Next, the operations of the centrifuge 1 having the aforementioned structure will be described. The motor 6 begins operating when a user pushes a start switch (not shown) on the centrifuge 1. At this time, the motor 6 drives the output shaft 6A to rotate, and the driving force is transmitted from the output shaft 6A to the drive shaft 7B via the belt 8A. As the drive shaft 7B rotates, the rotor 9 rotates in association therewith and separates a target material from the sample in the rotor 9. The rotation of the rotor 9 produces vibrations in the shaft unit 7, motor base 5, and motor 6, but the dampers 4 can attenuate these vibrations.

As described above, the third opening 2e is formed in the base 2B in a region opposing the center region of the belt 8A between the first and second pulleys 8B and 8C. Therefore, an operator can easily inspect the tension in the belt 8A through the third opening 2e after removing the cover 11, without exposing any components positioned above the belt 8A (in other words, without disassembling the body of the centrifuge 1), thereby reducing the time required for inspecting the belt tension. Here, tension in the belt is checked using an ultrasound tensiometer to measure the sound generated when plucking the belt 8A with a finger. The tension can also be checked by pushing the belt 8A or by using a spring to push or pull the belt with a fixed force while measuring displacement in the belt. Further, the first and second openings 2c and 2d are formed in the base 2B at positions opposing the first and second pulleys 8B and 8C. Therefore, an operator can easily replace the belt 8A through the first and second openings 2c and 2d after removing the cover 11, without exposing parts positioned above the belt 8A, thereby shortening the time required for the replacement operation.

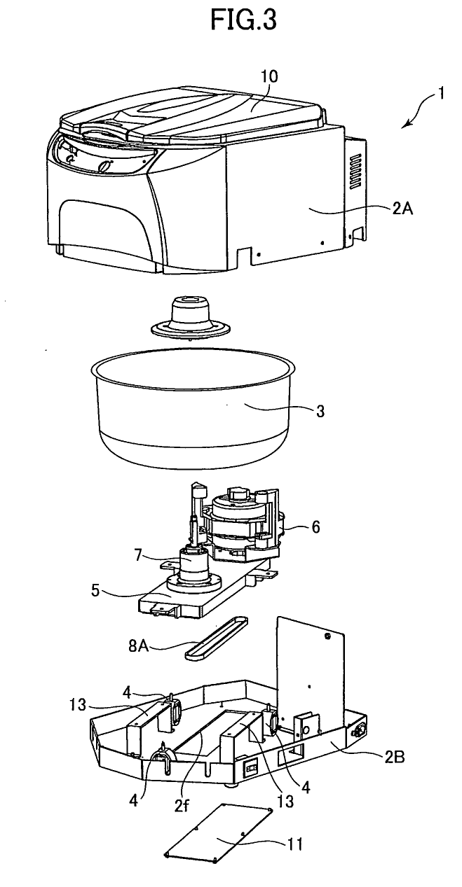

While the invention has been described in detail with reference to specific embodiments thereof, it would be apparent to those skilled in the art that many modifications and variations may be made therein without departing from the spirit of the invention, the scope of which is defined by the attached claims. For example, while three openings 2c-2e are formed in the base 2B in the preferred embodiment described above, it is also possible to form a single opening 2f in a region of the base 2B opposing the entire belt 8A, as shown in FIG. 3. This construction can obtain the same effects described above for the preferred embodiment. Further, while three openings 2c-2e are formed in the base 2B in the preferred embodiment described above, only the opening 2e or the openings 2c and 2d may be formed in the base 2B.

What is claimed is:

1. A centrifuge comprising:
a frame having a bottom portion;
a motor that is disposed in the frame to generate a driving force;
a output shaft that extends from the motor and that has an end positioned in proximity to the bottom portion;
a rotational shaft that is disposed in the frame and that has one end positioned in proximity to the bottom portion; and
a belt that is supported on the end of the output shaft and the one end of the rotational shaft, wherein the bottom portion is formed with an opening that opposes at least part of the belt.

2. The centrifuge according to claim 1, wherein the opening includes:
a first opening that opposes the one end of the rotational shaft; and
a second opening that opposes the end of the output shaft.

3. The centrifuge according to claim 2, wherein the opening further includes a third opening that opposes an approximate center region between the one end of the rotational shaft and the end of the output shaft.

4. The centrifuge according to claim 1, wherein the opening opposes an approximate center region between the one end of the rotational shaft and the end of the output shaft.

5. The centrifuge according to claim 1, wherein the opening is formed to oppose an entire length of the belt.

6. The centrifuge according to claim 1, further comprising:
a bowl that is disposed in the frame and that defines a rotor chamber, the rotational shaft having another end positioned inside the bowl;
a rotor that is mounted on the another end of the rotational shaft;
a damper that is provided on the bottom portion;
a bearing that rotatably supports the rotational shaft; and
a motor base supported on the bottom portion via the damper for supporting the motor and the bearing.
